(19) United States
(12) Patent Application Publication
(10) Pub. No.: US 2005/0275378 A1
(43) Pub. Date: Dec. 15, 2005

(54) Apparatus and method for illuminated battery charging device

(76) Inventors: Serafino Canino, Torrington, CT (US); Scott Gelormino, Unionville, CT (US)

Correspondence Address: CANTOR COLBURN, LLP, 55 GRIFFIN ROAD SOUTH, BLOOMFIELD, CT, 06002, US

(21) Appl. No.: 10/867,562

(22) Filed: Jun. 14, 2004

(51) Int. Cl. H02J 7/00

(52) U.S. Cl. 320/132

(57) ABSTRACT

A battery charging device and a method for indicating a status of a charging current are provided. The battery charging device includes a translucent housing adapted to provide a charging current. The battery charging device further includes at least one first light-emitting device disposed within the translucent housing, wherein the first light-emitting device illuminates a portion of the translucent housing in a first color when the charging current is being provided. Finally, the battery charging device includes at least one second light-emitting device disposed within the translucent housing, wherein the second light-emitting device illuminates a portion of the translucent housing in a second color when the charging current is no longer being provided.

### TECHNICAL FIELD

The application relates generally to an illuminated battery charging device for a rechargeable battery and a method for indicating a status of a charging current in the battery charging device.

### BACKGROUND

Rechargeable batteries have been developed that can be electrically recharged in a charging device. Typically, dead batteries are inserted into the charging device and by trial and error the battery is pulled from the charger and used, wherein the user may not know if the battery has been fully charged. Further, charging devices do not include a charging status indicator that can be seen several feet away from the charging devices.

Accordingly, there is a need for a battery charging device that can indicate a visually discernable charging status of a charging current at relatively large distances from the battery charging device.

### SUMMARY

A battery charging device in accordance with an exemplary embodiment is provided. The battery charging device includes a translucent housing adapted to provide a charging current. The battery charging device further includes at least one first light-emitting device disposed within the translucent housing, wherein the first light-emitting device illuminates a portion of the translucent housing in a first color when the charging current is being provided. Finally, the battery charging device includes at least one second light-emitting device disposed within the translucent housing, wherein the second light-emitting device illuminates a portion of the translucent housing in a second color when the charging current is no longer being provided.

A method for indicating a charging status of a charging current provided by a battery charging device in accordance with another exemplary embodiment is provided. The battery charging device has a translucent housing and at least first and second light-emitting devices disposed within the translucent housing. The method includes inducing the first light-emitting device to illuminate a portion of the translucent housing in a first color when the charging current is being provided. Finally, the method includes inducing the second light-emitting device to illuminate a portion of the translucent housing in a second color when the charging current is not being provided.

A battery charging device in accordance with another exemplary embodiment is provided. The battery charging device includes a translucent housing adapted to provide a charging current. The translucent housing has a first housing portion that is illuminated when a charging current is being provided and a second housing portion that is not illuminated while the charging current is being provided.

A battery charging device in accordance with another exemplary embodiment is provided. The battery charging device includes a translucent wall defining a receiving area for providing a charging current. The wall portion is illuminated when the charging current is being provided. Finally, the battery charging device includes a base portion coupled to the wall portion and supporting the wall portion.

Other systems and methods according to the embodiments will become or are apparent to one with skill in the art upon review of the following drawings and detailed description. It is intended that all such additional systems, methods, and/or computer program products be within the scope of the present invention, and be protected by the accompanying claims.

### BRIEF DESCRIPTION OF DRAWINGS

FIG. 1 is a perspective view of a battery charging device and a rechargeable battery;

FIG. 2 is a schematic of an electrical circuit for illuminating the battery charging device of FIG. 1;

FIG. 3 is a flowchart of a method for illuminating the battery charging device of FIG. 1;

FIG. 4 is a perspective view of a battery charging device in accordance with another exemplary embodiment;

FIG. 5 is a perspective view of a battery charging device in accordance with yet another exemplary embodiment; and,

FIG. 6 is a perspective view of a battery charging device in accordance with still another exemplary embodiment.

### DESCRIPTION OF EMBODIMENTS

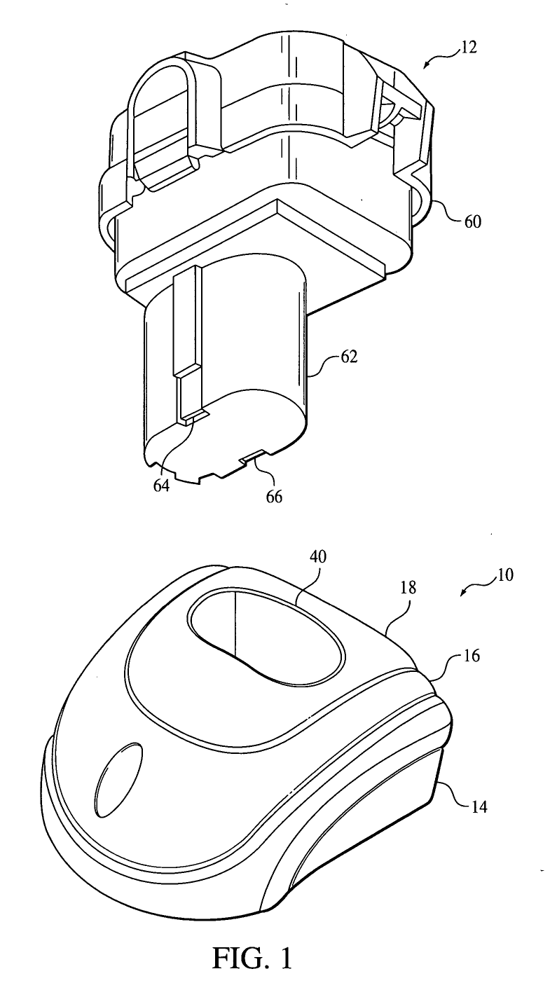

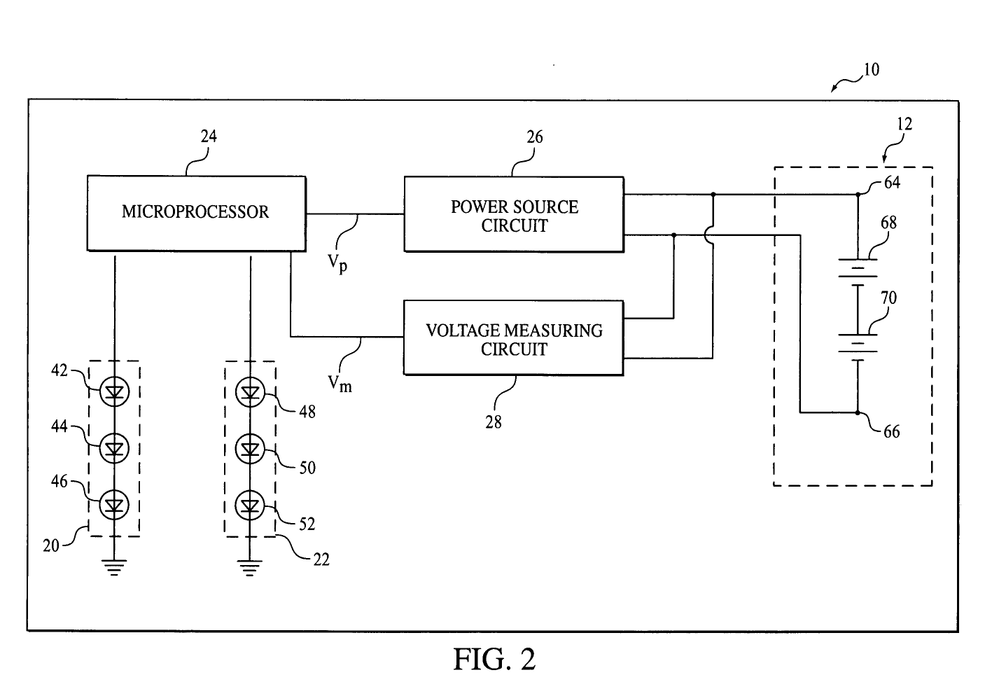

Referring to FIGS. 1 and 2, a battery charging device 10 for recharging a rechargeable battery 12 is illustrated. In accordance with an exemplary embodiment, a substantial portion of the housing of the battery charging device 10 is illuminated to indicate the status of a charging current indicative of a charging status of the battery 12. This will allow a user to determine the charging status from a distance. The battery charging device 10 includes a base housing portion 14, a translucent housing portion 16, a top housing portion 18, a first light-emitting device 20, a second light-emitting device 22, a microprocessor 24, a power source circuit 26, and a voltage measuring circuit 28.

The combination of the base housing portion 14, the translucent housing portion 16, and the top housing portion 18 are operably coupled together to form an enclosure for holding the remaining components of the battery charging device 10. The base housing portion 14 is constructed from opaque plastic and is operably coupled to the translucent housing portion 16 and the top housing portion 18 via screws (not shown). The top housing portion 18 is constructed from an opaque plastic and includes an aperture portion 40 for receiving a portion of the battery 12 to enable recharging of the battery 12.

The translucent housing portion 16 is constructed from a translucent plastic or any other easily molded material capable of providing a translucent or illuminated portion. The housing portion 16 has an upper surface 17 that extends substantially the entire length of the battery housing device 10. In the exemplary embodiment, the surface area 17 is generally U-shaped. In alternate embodiments, however, the surface area 17 can have a plurality of alternate shapes, such as a circular shape, a triangular shape, a hexagonal shape, for example.

The light-emitting device 20 is provided to illuminate the translucent housing portion 16 to allow a user to view the charging status of the battery 12 from a distance. The light-emitting device 20 is disposed within an interior of the battery charging device 10 and emits a green colored light when the battery 12 is being electrically charged. The light-emitting device 20 comprises light-emitting diodes (LEDs) 42, 44, and 46. In an alternate embodiment, the light-emitting device 20 comprises a plurality of additional LEDs disposed within the interior of the device 10 for illuminating the translucent housing portion 16. In yet another alternate embodiment, the light-emitting device 20 comprises one or more halogen bulbs disposed within the interior of the device 10 for illuminating the translucent housing portion 16. The LEDs 42, 44, and 46 are electrically connected in series between the microprocessor 24 and an electrical ground. The microprocessor 24 generates a control signal to induce the LEDs 42, 44, and 46 to emit light through the translucent housing portion 16. It should be noted that the LEDs of device 20 can be molded into the housing portion 16 or placed within features molded into the housing portion 16.

The light-emitting device 22 is provided to illuminate the translucent housing portion 16 to allow a user to view the charging status of the battery 12 from a distance. The light-emitting device 22 is disposed within an interior of the battery charging device 10 and emits a red colored light when the battery 12 is substantially fully charged. The light-emitting device 22 comprises LEDs 48, 50, and 52. In an alternate embodiment, the light-emitting device 22 comprises a plurality of additional LEDs disposed within the interior of the device 10 for illuminating the translucent housing portion 16. In yet another alternate embodiment, the light-emitting device 22 comprises one or more halogen bulbs disposed within the interior of the device 10 for illuminating the translucent housing portion 16. The LEDs 48, 50, and 52 are electrically connected in series between the microprocessor 24 and an electrical ground. The microprocessor 24 generates a control signal to induce the LEDs 48, 50, and 52 to emit light through the translucent housing portion 16. It should be noted that the LEDs of device 22 can be molded into the housing portion 16 or placed within features molded into the housing portion.

In another exemplary embodiment, the light emitting devices 20 and 22 comprise a single device or a set of devices wherein each device emits both a green light and a red light. In other words, each device emits a green color through the translucent housing portion when the battery 12 is being electrically charged, and each device emits a red color through the translucent housing portion when the battery 12 is substantially fully charged.

It should be further noted that in any of the embodiments, the emitted light from the first and second light emitting devices 20 and 22 can be any two different colors or light intensities and a similar or the same color, which are visually discernable by an observer. In yet another embodiment, light may be generated when the battery is charged.

The microprocessor 24 is provided to control the light-emitting devices 20 and 22 illuminating the device 10, and to control the electrical charging of the battery 12. The microprocessor 24 is electrically coupled to the light-emitting devices 20 and 22, the power source circuit 26, and the voltage measuring circuit 28. The voltage measuring circuit 28 is provided to measure a voltage across terminals 64 and 66 of the battery 12 indicative of a charging current to determine the charging status of the battery 12. The voltage measuring circuit 28 generates a signal (Vm) indicative of the charging current and further indicative of the charging status of the battery 12 that is received by the microprocessor 24.

When the signal (Vm) is below a predetermined threshold value, the microprocessor 24 generates a control signal (Vp) that is received by the power source circuit 26. In response to the control signal (Vp), the power source circuit 26 applies a charging voltage to the terminals 64 and 66 of the battery 12. Further, the microprocessor 24 induces the light-emitting device 20 and a green light through the translucent housing portion 16 to indicate the battery 12 is being electrically charged.

When the signal (Vm) is greater than or equal to a predetermined threshold value, the microprocessor 24 stops generating the control signal (Vp). In response, the power source circuit 26 stops applying a charging voltage to the terminals 64 and 66 of the battery 12. Further, the microprocessor 24 induces the light-emitting device 22 to emit a red light through the translucent housing portion 16 to indicate the battery 12 is substantially fully charged.

The rechargeable battery 12 is configured to supply electrical power to a power tool (not shown). The battery 12 includes a battery housing portion 60, a guide portion 62, terminals 64 and 66, and battery cells 68 and 70.

The battery housing portion 60 is provided to enclose the battery cells 68 and 70 and is constructed from plastic. The guide portion 62 is operably coupled to the battery housing portion 60 and is provided to be inserted into the aperture 40 of the top housing portion 18. When the guide portion 62 is inserted into the aperture 40, the power source circuit 26 is electrically coupled to the terminals 64 and 66 to transmit a charging voltage to the battery cells 68 and 70. The battery cells 68 and 70 comprise nickel-metal hydride battery cells. In another embodiment, the battery 12 can comprise one or more battery cells electrically coupled in series. Further, in other exemplary embodiments, the battery 12 can have one or more: (i) carbon zinc battery cells, (ii) nickel cadmium battery cells, (iii) lead acid battery cells, (iv) lithium ion battery cells, (v) alkaline manganese dioxide zinc battery cells, (vi) lithium manganese dioxide battery cells, or (vii) silver zinc oxide battery cells.

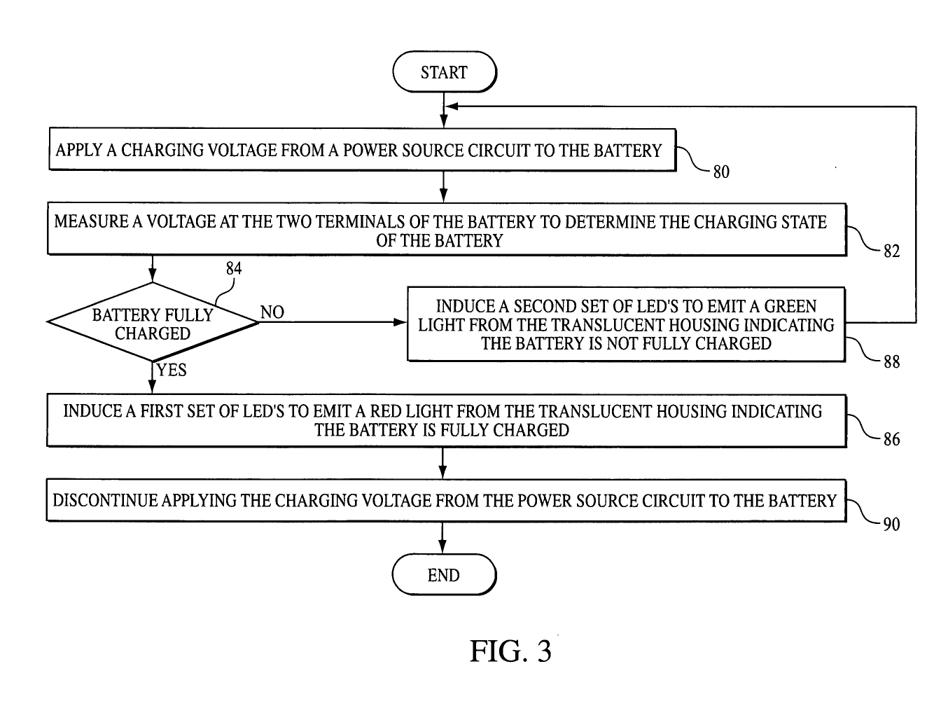

Referring now to FIG. 3, a method for indicating a status of a charging current and a charging status of the rechargeable battery 12 in the battery charging device 10 will now be explained. At step 80, the microprocessor 24 generates the control signal (Vp) to induce the power source 26 to apply a charging voltage to the battery 12.

At step 82, the voltage measuring circuit 28 measures a voltage at terminals 64 and 68 of the battery 12 to determine a status of a charging current or charging status of the battery 12. In particular, the circuit 28 generates the signal (Vm) indicative of the status of a charging current or charging status of the battery 12 that is transmitted to the microprocessor 24.

At step 84, the microprocessor 24 makes determination as to whether the battery 12 is fully charged. If the value of step 84 equals “no”, the method advances to step 88.

At step 88, the microprocessor 24 induces the LEDs 42, 44, and 46 to emit a green light from the translucent housing portion 16 indicating the battery 12 is not fully charged. The LEDs 42, 44 and 46 emit the green light through the relatively large translucent housing portion 16 that can be viewed by user at a relatively large distance from the battery charging device 10. For example, the illuminated translucent housing portion 16 can be viewed at least 75 feet from the battery charging device 10. Thereafter, the method advances to the step 80.

Referring again to step 84, if the value of step 84 equals “yes”, the method advances to step 86. At step 86, the microprocessor 24 induces the LEDs 48, 50, and 52 to emit a red light from the translucent housing portion 16 indicating the battery 12 is substantially fully charged. The LEDs 48, 50, and 52 emit the red light, indicative of a fully charged state of the battery 12, through the translucent housing portion 16 that can be viewed by user at a relatively large distance from the battery charging device 10.

Next at step 90, the microprocessor 24 induces the power source circuit 26 to discontinue applying the charging voltage to the battery 12.

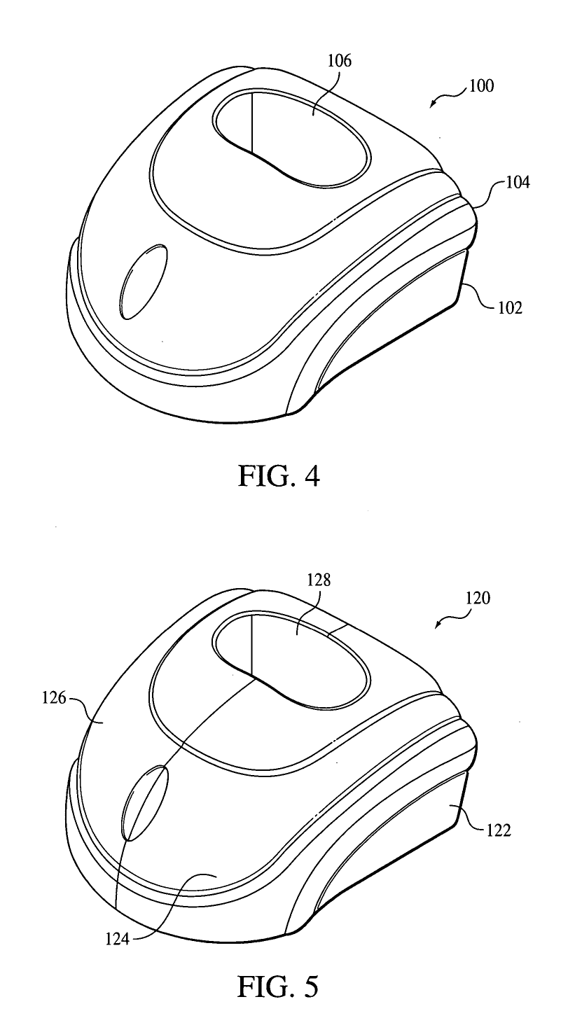

Referring to FIG. 4, a battery charging device 100 in accordance with another exemplary embodiment is provided. The primary difference between the battery charging device 100 and the battery charging device 10 is that the battery charging device 100 has a housing constructed substantially entirely from a translucent plastic. In an alternate embodiment, battery charging device can be constructed from any other easily molded material capable of providing a translucent or illuminated portion.

When the battery charging device 100 is internally illuminated by light-emitting devices, the device 100 can be viewed by a user at relatively large distances from the device 100. Accordingly, the user can visually perceive the status of a charging current applied to the battery 12 at relatively large distances from the device 100. For example, the user can visually perceive the status of the charging current at least 75 feet from the device 100.

The battery charging device 100 includes a translucent base housing portion 102 and a translucent top housing portion 104. The housing portions 102 and 104 are constructed from a translucent plastic and are operably coupled together using screws (not shown). The housing portion 104 forms the aperture portion 106 for receiving a guide portion 62 of the battery 12. Although not shown, the battery charging device 100 further includes the microprocessor 24, the power source circuit 26, the voltage measuring circuit 28, and the light-emitting devices 20 and 22.

During operation of the battery charging device 100 when the battery 12 is substantially fully charged, the light-emitting device 22 illuminates both the translucent base housing portion 102 and a translucent top housing portion 104 by emitting a red light. Alternately, when the battery 12 is not substantially fully charged, the light-emitting device 22 illuminates both the translucent base housing portion 102 and the translucent top housing portion 104 by emitting a green light.

Referring to FIG. 5, a battery charging device 120 in accordance with another exemplary embodiment is provided. The primary difference between the battery charging device 120 and the battery charging device 100, is that the battery charging device 120 has two top translucent housing portions wherein only one of the top translucent housing portions is illuminated at any given time to indicate the charging status of the battery 12.

When the battery charging device 120 is internally illuminated by the light-emitting devices, one of the top translucent housing portions can be viewed by a user at relatively large distances from the device 120. Accordingly, the user can visually perceive the status of a charging current applied to the battery 12 at relatively large distances from the device 120. For example, the user can visually perceive the status of the charging current at least 75 feet from the battery charging device 120.

The battery charging device 120 includes a translucent base housing portion 122 and translucent top housing portions 124 and 126. The housing portions 122, 124, and 126 are constructed from a translucent plastic and are operably coupled together using screws (not shown). The housing portion portions 124 and 126 form the aperture portion 128 for receiving a guide portion 62 of the battery 12. Although not shown, the battery charging device 120 further includes the microprocessor 24, the power source circuit 26, the voltage measuring circuit 28, and the light-emitting devices 20 and 22.

During operation of the battery charging device 120 when the battery 12 is substantially fully charged, the light-emitting device 22 illuminates the top translucent housing portion 124 by emitting a red light. Alternately, when the battery 12 is not substantially fully charged, the light-emitting device 20 illuminates top translucent housing portion 126 by emitting a green light.

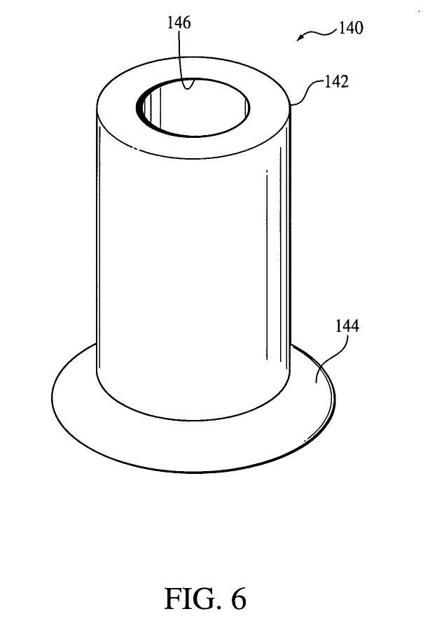

Referring to FIG. 6, a battery charging device 140 in accordance with another exemplary embodiment is provided. When the battery charging device 140 is internally illuminated by light-emitting devices, the device 140 can be viewed by a user at relatively large distances from the device 140. Accordingly, the user can visually perceive a status of a charging current applied to the battery 12 at relatively large distances from the device 140. For example, the user can visually perceive the charging status of the charging current at least 75 feet from the device 140.

The battery charging device 140 includes a translucent base portion 144 and a translucent wall 142. The wall 142 is constructed from a translucent plastic and the base portion 144 is constructed from an opaque plastic. In an alternate embodiment, wall 142 can be constructed from any other easily molded material capable of providing a translucent or illuminated portion. The wall 142 and the base portion 144 are operably coupled together using screws (not shown). The wall 142 is generally cylindrically shaped and forms an aperture portion 146 for receiving a guide portion 62 of the battery 12. It should be noted, however, the shape of the wall 142 can be alternate shapes depending upon the shape of the battery housing to be received by the battery charging device 140. Although not shown, the battery charging device 140 further includes the microprocessor 24, the power source circuit 26, the voltage measuring circuit 28, and the light-emitting devices 20 and 22 disposed therein.

During operation of the battery charging device 140 when the battery 12 is substantially fully charged, the light-emitting device 22 illuminates the wall 142 by emitting a red light. Alternately, when the battery 12 is not substantially fully charged, the light-emitting device 22 illuminates the wall 142 by emitting a green light.

It should be noted that any of the battery charging device embodiments disclosed herein can be configured to charge one or more types of batteries known to those skilled in the art. Non-limiting examples of battery types that can be charged include: AA batteries, AAA batteries, C batteries, and D batteries, camera batteries, camcorder batteries, and vehicle batteries.

The battery charging device for a rechargeable battery and the method for indicating the charging status of the rechargeable battery provide a substantial advantage over other systems and methods. In particular, the battery charging device and method indicates the charging status of a rechargeable battery that can be viewed at relatively large distances from the battery charging device. Accordingly, a user can visually perceive the a status of a charging current applied to the rechargeable battery without having to periodically move within close proximity to the battery charging device.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the term's first, second, etc. does not denote any order of importance, but rather the term's first, second, etc. are used to distinguish one element from another.

1. A battery charging device, comprising:
a translucent housing adapted to provide a charging current;
at least one first light-emitting device disposed within the translucent housing, wherein the first light-emitting device illuminates a portion of the translucent housing in a first color when the charging current is being provided; and
at least one second light-emitting device disposed within the translucent housing, wherein the second light-emitting device illuminates a portion of the translucent housing in a second color when the charging current is no longer being provided.

2. The battery charging device of claim 1, wherein the housing is constructed from a translucent plastic.

3. The battery charging device of claim 1, wherein the first light-emitting device illuminates substantially all of the translucent housing in the first color.

4. The battery charging device of claim 1, wherein the second light-emitting device illuminates substantially all of the translucent housing in the second color.

5. The battery charging device of claim 1, wherein the first color comprises a green color.

6. The battery charging device of claim 1, wherein the second color comprises a red color.

7. The battery charging device of claim 1, wherein the first light-emitting device illuminates substantially a first half of the translucent housing in the first color.

8. The battery charging device of claim 7, wherein the second light-emitting device illuminates substantially a second half of the translucent housing in the second color.

9. The battery charging device of claim 1, wherein the translucent housing comprises an aperture portion configured to receive a rechargeable battery.

10. The battery charging device of claim 1, wherein the first light-emitting device illuminates a first elongated portion of the translucent housing extending substantially the length of the translucent housing in the first color.

11. The battery charging device of claim 1, wherein the second light-emitting device illuminates a second elongated portion of the translucent housing extending substantially the length of the translucent housing in the second color.

12. The battery charging device of claim 1, wherein the first light-emitting device comprises a plurality of light-emitting diodes.

13. The battery charging device of claim 1, wherein the first and second light-emitting device are one and the same and are configured to emit both the first and second colors of light.

14. The battery charging device of claim 1, wherein the housing is visually perceptible at a predetermined distance from the housing.

15. A method for indicating a charging status of a charging current provided by a battery charging device, the battery charging device having a translucent housing and at least first and second light-emitting devices disposed within the translucent housing, the method comprising:
inducing the first light-emitting device to illuminate a portion of the translucent housing in a first color when the charging current is being provided; and
inducing the second light-emitting device to illuminate a portion of the translucent housing in a second color when the charging current is not being provided.

16. The method of claim 15, wherein the first light-emitting device illuminates substantially all of the translucent housing in the first color.

17. The method of claim 15, wherein the second light-emitting device illuminates substantially all of the translucent housing in the second color.

18. The method of claim 15, wherein the first color comprises a green color.

19. The method of claim 18, wherein the second color comprises a red color.

20. The method of claim 15, wherein the first light-emitting device illuminates substantially a first half of the translucent housing in the first color.

21. The method of claim 20, wherein the second light-emitting device illuminates substantially a second half of the translucent housing in the second color.

22. The method of claim 15, wherein the first light-emitting device illuminates a first elongated portion of the translucent housing extending substantially the length of the translucent housing in the first color and the second light-emitting device illuminates a second elongated portion of the translucent housing extending substantially the length of the translucent housing in the second color.

23. A battery charging device, comprising:
a translucent housing adapted to provide a charging current, the translucent housing having a first housing portion that is illuminated when a charging current is being provided and a second housing portion that is not illuminated while the charging current is being provided.

24. The battery charging device of claim 23, wherein the second housing portion comprises a base portion for supporting the first housing portion.

25. The battery charging device of claim 23, wherein the translucent housing is constructed from a translucent plastic.

26. A battery charging device, comprising:
a translucent wall defining a receiving area for providing a charging current, the wall portion being illuminated when the charging current is being provided; and
a base portion coupled to the wall portion and supporting the wall portion.

27. The battery charging device of claim 26, wherein the translucent wall is constructed from a translucent plastic.
